(19) United States
(12) Patent Application Publication
(10) Pub. No.: US 2001/0034456 A1
(43) Pub. Date: Oct. 25, 2001

(54) Catalysts for isomerizing dichlorobutenes

(76) Inventors: Peter Schertl, Leverkusen (DE); Josef Sanders, Leverkusen (DE)

Correspondence Address: BAYER CORPORATION, PATENT DEPARTMENT, 100 BAYER ROAD, PITTSBURGH, PA, 15205, US

(21) Appl. No.: 09/808,433

(22) Filed: Mar. 14, 2001

(30) Foreign Application Priority Data
Mar. 16, 2000 (DE) 10012742.8

(51) Int. Cl. C08F 4/42; C07F 15/02

(52) U.S. Cl. 556/144; 526/169

(57) ABSTRACT

This invention relates to a composition producible by mixing an iron carbonyl complex selected from among the group Fe(CO)₅, Fe₂(CO)₉, Fe₃(CO)₁₂ or of anhydrous iron salts FeₘXₙ, wherein m=1 or 2 and n=2 or 3 and X=halide, carbonate, nitrate, nitrite, sulfide, sulfate, phosphate, rhodanide, acetate, acetylacetonate or a mixture of two or three of these compounds with a cyclopentadiene derivative of the general formula I,

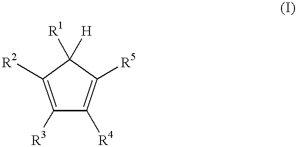

wherein

R¹ to R⁵ mutually independently denote H, C₁ to C₁₂ alkyl, C₅ to C₈ cycloalkyl, which may in turn bear C₁ to C₁₂ alkyl groups, C₆ to C₁₄ aryl, alkylaryl, arylalkyl, wherein two adjacent residues may together form saturated or unsaturated C₃ to C₁₄ cycles, or denote —SiR⁶R⁷R⁸, wherein R⁶ to R⁷ may mutually independently mean C₁ to C₄ alkyl, C₅ to C₈ cycloalkyl or C₆ to C₁₄ aryl, and 1,4-dichloro-2-butene and/or 3,4-dichloro-1-butene, and to the use thereof as a catalyst, in particular in a process for isomerizing 1,4-dichloro-2-butene to yield 3,4-dichloro-1-butene or vice versa.

### FIELD OF THE INVENTION

This invention relates to a composition producible by mixing an iron compound selected from among the group of iron carbonyls, Fe(CO)₅, Fe₂(CO)₉, Fe₃(CO)₁₂ or of anhydrous iron salts FeₘXₙ, wherein m=1 or 2 and n=2 or 3 and X=halide, carbonate, nitrate, nitrite, sulfide, sulfate, phosphate, rhodanide, acetate, acetylacetonate or a mixture of two or more of these compounds with a cyclopentadiene derivative of the general Formula I,

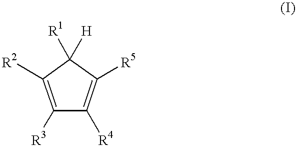

wherein

R¹ to R⁵ mutually independently denote H, C₁ to C₁₂ alkyl, C₅ to C₈ cycloalkyl, which may in turn bear C₁ to C₁₂ alkyl groups, C₆ to C₁₄ aryl, alkylaryl, arylalkyl, wherein two adjacent residues may together form saturated or unsaturated C₃ to C₁₄ cycles, or denote —SiR⁶R⁷R⁸, wherein R⁶ to R⁸ may mutually independently mean C₁ to C₄ alkyl, C₅ to C₈ cycloalkyl or C₆ to C₁₄ aryl, and to the use thereof as a catalyst, in particular in a process for isomerizing 1,4-dichloro-2-butene to yield 3,4-dichloro-1-butene or vice versa.

### BACKGROUND OF THE INVENTION

3,4-Dichloro-1-butene is an important intermediate in the production of 2-chloroprene, which is used on a large industrial scale as a monomer in the production of polychloroprene rubber.

When butadiene is chlorinated, a mixture of cis-1,4-dichloro-2-butene, trans-1,4-dichloro-2-butene and 3,4-dichloro-1-butene is obtained which contains approx. 65% cis- and trans-1,4-dichloro-2-butene and approx. 35% 3,4-dichloro-1 -butene. These isomers are usually present in the mixture in equilibrium, wherein the ratio is determined by production conditions. For simplicity's sake, cis- and trans-1,4-dichloro-2-butene are hereinafter referred to together as 1,4-dichloro-2-butene. This mixture may be separated by distillation on the basis of differing boiling points (1,4-dichloro-2-butene: 154-9° C. and 3,4-dichloro-1-butene: 123° C.). Since only 3,4-dichloro-1-butene is suitable for the production of 2-chloroprene, the 1,4-dichloro-2-butene must be isomerized to yield 3,4-dichloro-1-butene and returned to the process.

Conventional processes for isomerizing 1,4-dichloro-2-butene to yield 3,4-dichloro-1-butene or vice versa are based upon the use of suitable isomerization catalysts, which ensure that equilibrium is rapidly established between the isomers in 1,4-dichloro-2-butene or 3,4-dichloro-1-butene at elevated temperatures. In most processes, metal salts of copper are used in the presence of further additives, which serve to achieve elevated reaction rates.

DE-A-2 138 790 discloses a process for isomerizing 1,4-dichloro-2-butene to yield 3,4-dichloro-1-butene or vice versa at 80 to 160° C. by means of copper naphthenate, dinitrile and amide. DE-A-2 143 157 describes an isomerization process in the presence of copper salts and oxime derivatives at 80 to 160° C. DE-A-2 200 780 claims a process which contains a mixture of a copper compound and an organic phosphorus compound as catalyst. DE-A-2 107 468 discloses the use of copper naphthenate and nitro compounds, while DE-A-2 130 488 discloses the use of copper naphthenate and nitroanilines. DE-A-2 212 235 describes an isomerization process by means of a copper compound and urea derivative. DE-A-2 206 971 claims the use of a mixture of copper compound and an aniline derivative containing chlorine. U.S. Pat. No. 4,895,993 describes an isomerization process in the presence of a catalyst consisting of a copper compound and a dithiocarbamate or trithiocarbamate derivative.

Rostovshchikova et al. describe in Zh. Obschch. Khim. 1994, 64, 12 the use of triphenylphosphine or in Kinet. Katal. 1992, 33, 314 the use of various dialkyl sulfides in the presence of copper halides for catalytic isomerization. In Arm. Khim. Zh. 1987, 40, 709, Asatryan et al. describe the action of various isomerization catalysts based on halide salts of copper, iron or zinc in the presence of amine derivatives such as triethylamine, diethylamine, triethanolamine, ethylenediamine or aniline. Asatryan et al. investigated in Arm. Khim. Zh. 1988, 41, 278 the action of macrocyclic polyethers or polyethylene glycols and in Arm. Khim. Zh. 1988, 41, 273 the influence of benzonitrile, nitrobenzene, DMF, dimethyl sulfone or acetophenone.

A disadvantage of all these processes is that the transformation rates are comparatively low and a large quantity of unwanted secondary products is formed. Moreover, elevated concentrations of the particular catalysts are required in order to achieve economically necessary isomerization rates, which entails considerable effort in recovering the catalyst and gives rise to large quantities of waste containing heavy metals. The described systems are furthermore extremely corrosive and require special materials if it is to be possible to perform the isomerization on an industrial scale.

In J. Organomet. Chem. 1971, 29, 307-311, Henrici-Olivé and Olivé describe catalysts for isomerizing dichlorobutenes, among which cyclopentadienyliron dicarbonyl dimer, [CpFe(CO)₂]₂, wherein Cp denotes cyclopentadienyl, has proved to be a highly active catalyst, which may be used without the addition of activity-promoting additives. The disadvantage of the described catalyst is its high price, which does not justify use on an industrial scale.

### SUMMARY OF THE INVENTION

The object of the present invention was accordingly to provide a catalyst system which firstly ensures elevated transformation rates, catalyses isomerization selectively and with reduced formation of secondary products, may be used at low concentration and gives rise to less corrosion.

This object is achieved by the provision of a composition producible by mixing an iron compound selected from among the group of iron carbonyls, Fe(CO)₅, Fe₂(CO)₉, Fe₃(CO)₁₂ or of anhydrous iron salts FeₘXₙ, wherein m=1 or 2 and n=2 or 3 and X=halide, carbonate, nitrate, nitrite, sulfide, sulfate, phosphate, rhodanide, acetate, acetylacetonate or a mixture of two or more of these compounds with a cyclopentadiene derivative of the general formula I,

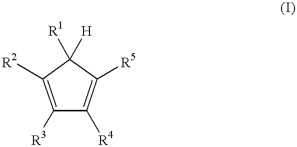

wherein

R¹ to R⁵ mutually independently denote H, C₁ to C₁₂ alkyl, C₅ to C₈ cycloalkyl, which may in turn bear C₁ to C₁₂ alkyl groups, C₆ to C₁₄ aryl, alkylaryl, arylalkyl, wherein two adjacent residues may together form saturated or unsaturated C₃ to C₁₄ cycles, or denote —SiR⁶R⁷R⁸, wherein R₅ to R₈ may mutually independently mean C₁ to C₄ alkyl, C₅ to C₈ cycloalkyl or C₆ to C₁₄ aryl, and 1,4-dichloro-2-butene and/or 3,4-dichloro-1-butene or a mixture of the two at temperatures in the range from 40 to 180° C., preferably in the range from 50 to 150° C.

C₁-C₁₂ alkyl are taken to mean all linear or branched, saturated or unsaturated alkyl residues having 1 to 12 C atoms known to the person skilled in the art, such as methyl, ethyl, n-propyl, i-propyl, n-butyl, i-butyl, t-butyl, n-pentyl, i-pentyl, neopentyl, n-hexyl, i-hexyl, heptyl, octyl, nonyl, decyl, undecyl and dodecyl, together with the unsaturated homologues thereof.

C₅ to C₈ cycloalkyl are taken to mean all cyclic alkyl residues having 5 to 8 C atoms known to the person skilled in the art, such as cyclopentyl, cyclohexyl, cycloheptyl, cyclooctyl, together with the unsaturated homologues thereof.

C₆ to C₁₄ aryl are taken to mean all aryl residues having 6 to 14 C atoms known to the person skilled in the art, such as phenyl, naphthenyl, fluorenyl, anthracenyl and phenanthranyl.

Preferred cyclopentadiene derivatives are methylcyclopentadiene, pentamethylcyclopentadiene, trimethylsilylcyclopentadiene, indene, fluorene, 1-trimethylsilylindene, cyclopentadiene dimer or mixtures of two, three or more of these components.

The ratio of the two components, iron compound to cyclopentadiene derivative, is, advantageously, in the case of Fe(CO)₅, in the range from 1:0.8-1.2, preferably 1:1, in the case of Fe₂(CO)₉, in the range from 1:1.7-2.3, preferably 1:2, in the case of Fe₃(CO)₁₂ in the range from 1:2.6-3.4, preferably 1:3, in the case of the anhydrous iron salt FeₘXₙ, wherein m=1 or 2 and n=2 or 3 and X=halide, carbonate, nitrate, nitrite, sulfide, sulfate, phosphate, rhodanide, acetate, acetylacetonate, where m=1 in the range from 1:0.8-1.2, preferably 1:1, where m=2 in the range from 1:1.6-2,4, preferably 1:2. The total concentration of the two components is advantageously in the range from 10⁻⁵ to 10⁻¹ mol/L, preferably between 10⁻⁴ to 10⁻² mol/L.

The present invention, furthermore, relates to a process for the production of a composition according to the invention, characterized in that the components are mixed. The sequence in which the mixture components are added is generally immaterial. It is advantageous to perform this mixing operation under a protective gas atmosphere, such as a nitrogen atmosphere or argon atmosphere, in a temperature range from 40 to 180° C., preferably from 80 to 150° C.

The invention, furthermore, relates to the use of the composition according to the present invention as a catalyst, in particular as a catalyst in a process for isomerizing 1,4-dichloro-2-butene to yield 3,4-dichloro-1-butene or 3,4-dichloro-1-butene to yield 1,4-dichloro-2-butene.

The invention accordingly also provides a process for isomerizing 1,4-dichloro-2-butene to yield 3,4-dichloro-1-butene or 3,4-dichloro-1-butene to yield 1,4-dichloro-2-butene, wherein the process comprises

a) an iron compound selected from among the group of iron carbonyls, Fe(CO)₅, Fe₂(CO)₉, Fe₃(CO)₁₂ or of anhydrous iron salts FeₘXₙ, wherein m=1 or 2 and n=2 or 3 and X=halide, carbonate, nitrate, nitrite, sulfide, sulfate, phosphate, rhodanide, acetate, acetylacetonate or a mixture of two or more of these compounds with a cyclopentadiene derivative of the general formula I,

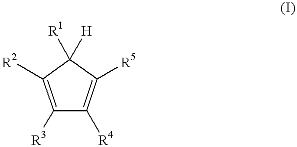

wherein

R¹ to R⁵ mutually independently denote H, C¹ to C¹² alkyl, C⁵ to C⁸ cycloalkyl, which may in turn bear C₁ to C₁₂ alkyl groups, C₆ to C₁₄ aryl, alkylaryl, arylalkyl, wherein two adjacent residues may together form saturated or unsaturated C3 to C,4 cycles, or denote —SiR⁶R⁷R⁸, wherein R⁶ to R⁸ may mutually independently mean C₁ to C₄ alkyl, C₅ to C₈ cycloalkyl or C₆ to C₁₄ aryl,

is added to 1 ,4-dichloro-2-butene or 3,4-dichloro-1-butene at a temperature in the range from 40 to 180° C., preferably in the range from 80 to 150° C., wherein the order in which the catalyst components are added is generally irrelevant,

b) the reaction solution is allowed to react until an equilibrium between 1,4-dichloro-2-butene and 3,4-dichloro-1-butene is established, preferably between 1 and 180 minutes, most preferably between 15 and 45 minutes,

c) a mixture of 1,4-dichloro-2-butene and 3,4-dichloro-1-butene is continuously removed and then separated by distillation,

d) the unwanted component from the distillation performed in c) is reintroduced into the reaction system and optionally

e) simultaneously with c), 1,4-dichloro-2-butene and/or 3,4-dichloro-1-butene is supplied to the reaction system.

The process may proceed both discontinuously and continuously at between 0.01 bar and 10 bar, preferably between 0.1 and 1.0 bar. It may be advantageous in step a) to mix the iron compound with the cyclopentadiene derivative before addition to the dichlorobutene(s) and to add the complete mixture instead of the individual components to the dichlorobutene(s). It is furthermore frequently advantageous initially to produce a relatively highly concentrated mixture of iron compound and cyclopentadiene derivative, preferably 10⁻² to 1 mol of Fe/L, in 1,4-dichloro-2-butene or 3,4-dichloro-1-butene and to add this continuously to a relatively large quantity of 1,4-dichloro-2-butene and/or 3,4-dichloro-1-butene, such that the desired concentration of the catalyst is obtained, wherein 1,4-dichloro-2-butene and/or 3,4-dichloro-1-butene is continuously supplied, a mixture of 1,4-dichloro-2-butene and 3,4-dichloro-1-butene is continuously removed and then separated by distillation.

The following practical Examples illustrate the invention in greater detail, but without restricting the invention to the Examples.

### EXAMPLES

### Example 1

240.0 g of 1,4-dichloro-2-butene and 39.7 mg (0.6 mmol) of cyclopentadiene are initially introduced under nitrogen into a 500 mL round-bottomed flask equipped with an internal thermometer, reflux condenser and pressure relief valve, 109.2 mg (0.3 mmol) of diiron nonacarbonyl are added at 120° C. and stirred for 3 h at this temperature.

Over the period of the reaction, samples are taken at specified intervals and tested by gas chromatography for the content thereof of 3,4-dichloro-1-butene, cis-1,4-d ichloro-2-butene, trans-1,4-dichloro-2-butene and any possibly formed secondary products, such as 1-chloroprene. The starting point of the reaction is defined by the addition of diiron nonacarbonyl. Samples, each of a volume of approx. 2 ml, are taken at the starting point, after 2, 5, 15, 30, 90 and 180 minutes.

### Example 2

240.0 g of 1,4-dichloro-2-butene and 13.2 mg (0.2 mmol) of cyclopentadiene are initially introduced into the test setup described in Example 1, 36.4 mg (0.1 mmol) of diiron nonacarbonyl are added at 140° C. and stirred for 3 h at this temperature. Sampling and testing of the samples proceed as stated in greater detail in Example 1.

### Example 3

240.0 g of 1,4-dichloro-2-butene and 46.7 mg (0.4 mmol) of indene are initially introduced into the test setup described in Example 1, 72.8 mg (0.2 mmol) of diiron nonacarbonyl are added at 140° C. and stirred for 3 h at this temperature. The timing and nature of sampling and testing of the samples proceed as stated in greater detail in Example 1.

### Example 4

240.0 g of 1,4-dichloro-2-butene and 138.3 mg (1.0 mmol) of trimethylsilylcyclopentadiene are initially introduced into the test setup described in Example 1, 181.9 mg (0.5 mmol) of diiron nonacarbonyl are added at 140° C. and stirred for 3 h at this temperature. The timing of sampling and testing of the samples proceed as stated in greater detail in Example 1.

### Example 5

240.0 g of 1,4-dichloro-2-butene and 79.3 mg (0.6 mmol) of dicyclopentadiene are initially introduced into the test setup described in Example 1, 109.2 mg (0.3 mmol) of diiron nonacarbonyl are added at 140° C. and stirred for 3 h at this temperature. The timing and nature of sampling and testing of the samples proceed as stated in greater detail in Example 1.

### Example 6

240.0 g of 1,4-dichloro-2-butene and 136.2 mg (1.0 mmol) of 1,2,3,4,5-pentamethylcyclopentadiene are initially introduced into the test setup described in Example 1, 181.9 mg (0.5 mmol) of diiron nonacarbonyl are added at 120° C. and stirred for 3 h at this temperature. The nature of sampling and testing of the samples proceed as stated in greater detail in Example 1. Samples are taken at the beginning of the reaction, ie. immediately after addition of the iron carbonyl, and after 15, 30, 60, 120 and 240 minutes.

### Example 7

Catalyst A

200.0 g of 1,4-dichloro-2-butene and 1.12 g (8.5 mmol) of dicyclopentadiene (analytical grade) are initially introduced under nitrogen into a 500 mL round-bottomed flask equipped with an internal thermometer, reflux condenser and pressure relief valve, stirred for 60 minutes at 50° C., 1.37 g (8.5 mmol) of iron(III) chloride are added and the mixture is then stirred for a further 60 minutes at this temperature. Once the catalyst solution is cool, a sample is taken and tested by gas chromatography for the content thereof of 3,4-dichloro-1 -butene and any possibly formed secondary products, such as 1-chloroprene.

### Example 8

Catalyst B

150.0 g of 1,4-dichloro-2-butene and 1.80 g (12.6 mmol) of dicyclopentadiene (93%) are initially introduced into the test setup described in Example 7, stirred for 60 minutes at 50° C., 2.05 g (12.6 mmol) of iron(III) chloride are added and then stirred for a further 60 minutes at this temperature. Once the catalyst solution is cool, a sample is taken and tested by gas chromatography.

### Example 9

Catalyst C

150.0 g of 1,4-dichloro-2-butene and 1.80 g (12.6 mmol) of dicyclopentadiene (93%) are initially introduced into the test setup described in Example 7, stirred for 60 minutes at 50° C., 1.60 g (12.6 mmol) of iron(II) chloride are added and then stirred for a further 60 minutes at this temperature. Once the catalyst solution is cool, a sample is taken and tested by gas chromatography.

### Example 10

240.0 g of 1,4-dichloro-2-butene are initially introduced at 130° C. into the test setup described in Example 1 and 12.15 g (0.5 mmol) of catalyst solution A produced in Example 7 are added and stirred for 120 minutes at this temperature. The starting point of the reaction is defined by the completion of addition of the catalyst solution. Samples, each of a volume of approx. 2 ml, are taken at the starting point, after 1, 2, 5, 15, 30, 60 and 120 minutes. The nature of sampling and testing of the samples proceed as stated in greater detail in Example 1.

### Example 11

240.0 9 of 1,4-dichloro-2-butene are initially introduced at 125° C. into the test setup described in Example 1 and 9.85 g (0.8 mmol) of catalyst solution B produced in Example 8 are added and stirred for 120 minutes at this temperature. The timing, nature of sampling and testing of the samples proceed as stated in greater detail in Example 10.

### Example 12

240.0 g of 1,4-dichloro-2-butene are initially introduced at 125° C. into the test setup described in Example 1 and 9.85 g (0.8 mmol) of catalyst solution C produced in Example 9 are added and stirred for 120 minutes at this temperature. The timing, nature of sampling and testing of the samples proceed as stated in greater detail in Example 10.

### Comparative Example 13

240.0 g of 1,4-dichloro-2-butene are initially introduced into the test setup described in Example 1, 60.8 mg (0.2 mmol) of dicarbonyidicyclopentadienyliron iodide are added at 1400C and stirred for 3 hours at this temperature. The timing and nature of sampling and testing of the samples proceed as stated in greater detail in Example 1.

### Comparative Example 14

240.0 g of 1,4-dichloro-2-butene are initially introduced into the test setup described in Example 1, 141.6 mg (0.4 mmol) of cyclopentadienyliron dicarbonyl dimer are added at 140° C. and stirred for 3 hours at this temperature. The timing and nature of sampling and testing of the samples proceed as stated in greater detail in Example 1.

### Comparative Example 15

Catalyst D

232.0 g of 1,4-dichloro-2-butene are initially introduced under nitrogen into a 500 mL round-bottomed flask equipped with an internal thermometer, reflux condenser and pressure relief valve, 9.5 g (94 mmol) of triethylamine are added at 50° C. and stirred for 4 h at this temperature. 10.3 g (104 mmol) of copper(I) chloride are then added at 50° C. and stirred for a further 8 h at this temperature.

### Comparative Example 16

240.0 g of 1 ,4-dichloro-2-butene are initially introduced into the test setup described in Example 1, 84 g of catalyst solution D produced in Example 15 are added at 130° C., such that a mixture temperature of 105° C. is established, and stirred for 3 h at this temperature. The nature of sampling and testing of the samples proceed as stated in greater detail in Example 1. Samples are taken at the starting point of the reaction, i.e. immediately after addition of the catalyst solution, and after 5, 30, 90, 180 and 360 minutes.

### Comparative Example 17

240.0 g of 1,4-dichloro-2-butene are initially introduced into the test setup described in Example 1, 84 g of catalyst solution D produced in Example 15 are added at 160° C., such that a mixture temperature of 130° C. is established, and stirred for 3 h at this temperature. The nature of sampling and testing of the samples proceed as stated in greater detail in Example 1. Samples are taken at the starting point of the reaction, i.e. immediately after addition of the catalyst solution, and after 5, 30, 90, 180 and 360 minutes.

The Examples according to the invention demonstrate that the conventional copper (I) chloride/triethylamine system gives rise to the formation of distinctly larger quantities of secondary products, that an elevated catalyst concentration is required in order to achieve adequate transformation rates and that isomerization efficiency is lower.

| | | | | | | Tem- |
|---|---|---|---|---|---|---|
| | | | Con- | | Con- | per- |
| | Catalyst | | centration | | centration | ature |
| Eg. | mixture | Complex^{a)} | [mmol/L] | Additive^{b)} | [mmol/L] | [° C.] |
| 1 | — | Fe₂(CO)₉ | 1.5 | CpH | 3.0 | 120 |
| 2 | — | Fe₂(CO)₉ | 0.5 | CpH | 1.0 | 140 |
| 3 | — | Fe₂(CO)₉ | 1.0 | Indene | 2.0 | 140 |
| 4 | — | Fe₂(CO)₉ | 2.5 | Me₃SiCpH | 5.0 | 140 |
| 5 | — | Fe₂(CO)₉ | 1.5 | DiCpH | 3.0 | 140 |
| 6 | — | Fe₂(CO)₉ | 2.5 | Cp*H | 5.0 | 120 |
| 10 | A | FeCl₃ | 2.5 | DiCpH | 2.5 | 130 |
| 11 | B | FeCl₃ | 4.0 | DiCpH | 4.0 | 125 |
| 12 | C | FeCl₃ | 4.0 | DiCpH | 4.0 | 125 |
| 13 | — | CpFe(CO)₂l | 1.0 | — | — | 140 |
| 14 | — | [CpFe | 2.0 | — | — | 140 |
| | | (CO)₂]₂ | | | | |
| 16 | D | CuCl | 128 | Et₃N | 115 | 105 |
| 17 | D | CuCl | 128 | Et₃N | 115 | 130 |

Content [%]

| | 3,4-dichloro-1-butene | | | | | | 1-chloroprene |
|---|---|---|---|---|---|---|---|
| Eg. | 0 min | 5 min | 15 min | 30 min | 90 min | 180 min | 180 min |
| 1 | 3.83 | 13.65 | 17.77 | 21.08 | 22.64 | 22.11 | 0.02 |
| 2 | 4.44 | 18.87 | 20.11 | 21.35 | 21.68 | 21.31 | 0.01 |
| 3 | 3.02 | 17.58 | 20.63 | 21.90 | 22.02 | 21.22 | 0.04 |
| 4 | 2.94 | 19.50 | 22.08 | 22.80 | 22.73 | 22.90 | 0.03 |
| 5 | 2.91 | 18.80 | 22.12 | 23.14 | 23.69 | 23.43 | 0.02 |
| 6 | 2.95 | n.d.^{f)} | 15.35 | 18.81 | 21.70^{c)} | 21.60^{d)} | 0.03^{d)} |
| 10 | 3.78 | 13.81 | 21.01 | 21.89 | 22.02^{e)} | 22.59^{c)} | 0.05^{c)} |
| 11 | 1.51 | 10.38 | 15.21 | 17.72 | 19.21^{e)} | 20.31^{c)} | 0.08^{c)} |
| 12 | 1.61 | 9.31 | 10.89 | 12.91 | 16.50^{e)} | 14.21^{c)} | 0.01^{c)} |
| 13 | 2.75 | 18.78 | 20.90 | 21.73 | 22.22 | 21.98 | 0.01 |
| 14 | 2.58 | 10.75 | 19.46 | 23.23 | 23.24 | 23.18 | 0.05 |
| 16 | 8.96 | 13.23 | n.d.^{f)} | 16.94 | 17.21 | 17.25 | 0.93 |
| 17 | 9.54 | 15.47 | n.d.^{f)} | 18.13 | 17.82 | 18.41 | 2.73 |

^{a)}Fe₂(CO)₉ = diiron nonacarbonyl, CpFe(CO)₂| = dicarbonyldicyclopentadienyliron iodide, [CpFe(CO)₂]₂ = cyclopentadienyliron dicarbonyl dimer
^{b)}CpH = cyclopentadiene, Me₃SiCpH = trimethylsilylcyclopentadiene, DiCpH = dicyclopentadiene, Cp*H = pentamethylcyclopentadiene
^{c)}after 120 min
^{d)}after 240 min
^{e)}after 60 min
^{f)}n.d. = not determined

Although the invention has been described in detail in the foregoing for the purpose and that variations can be made therein by those skilled in the art without departing from the spirit and scope of the invention except as it may be limited by the claims.

What is claimed is:

1. A composition comprising a mixture of an iron compound selected from the group consisting of iron carbonyls, Fe(CO)₅, Fe₂(CO)₉, Fe₃(CO)₁₂ or of anhydrous iron salts FeₘXₙ, wherein m=1 or 2 and n=2 or 3 and X=halide, carbonate, nitrate, nitrite, sulfide, sulfate, phosphate, rhodanide, acetate, acetylacetonate or a mixture of two or more of these compounds, with a cyclopentadiene derivative of the general formula 1, 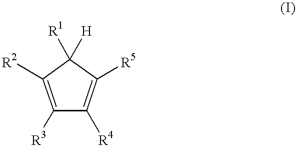
wherein
R¹ to R⁵ mutually independently denote H, C₁ to C₁₂ alkyl, C₅ to C₈ cycloalkyl, which may in turn bear C₁ to C₁₂ alkyl groups, C₆ to C₁₄ aryl, alkylaryl, arylalkyl, wherein two adjacent residues may together form saturated or unsaturated C₃ to C₁₄ cycles, or denote —SiR⁶R⁷R⁸, wherein R⁶ to R⁸ may mutually independently mean C₃ to C₁₄ alkyl, C₅ to C₈ cycloalkyl or C₆ to C₁₄ aryl, and 1,4-dichloro-2-butene, 3,4-dichloro-1-butene or a mixture of the two at temperatures in the range from 40 to 180° C.

2. Composition according to claim 1, wherein mixing is performed at temperatures in the range from 50 to 150° C.

3. Composition according to claim 1, wherein the cyclopentadiene derivative is selected from the group consisting of cyclopentadiene, methylcyclopentadiene, dicyclopentadiene, indene or any desired mixture of these compounds.

4. Composition according to claim 1, wherein said iron compound is an iron carbonyl compound.

5. Composition according to claim 1, wherein said iron compound is an iron halide.

6. Composition according to claim 5, wherein said iron compound is anhydrous iron(III) chloride and/or iron(II) chloride.

7. A catalyst comprising a composition which comprises a mixture of an iron compound selected from the group consisting of iron carbonyls, Fe(CO)₅, Fe₂(CO)₉, Fe₃(CO)₁₂ or of anhydrous iron salts FeₘXₙ, wherein m=1 or 2 and n=2 or 3 and X=halide, carbonate, nitrate, nitrite, sulfide, sulfate, phosphate, rhodanide, acetate, acetylacetonate or a mixture of two or more of these compounds, with a cyclopentadiene derivative of the general formula I, 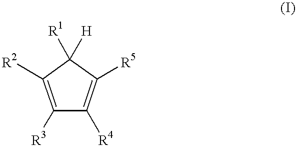
wherein
R¹ to R⁵ mutually independently denote H, C₁ to C₁₂ alkyl, C₅ to C₈ cycloalkyl, which may in turn bear C₁ to C₁₂ alkyl groups, C₆ to C₁₄ aryl, alkylaryl, arylalkyl, wherein two adjacent residues may together form saturated or unsaturated C₃ to C₁₄ cycles, or denote —SiR⁶R⁷R⁸, wherein R⁶ to R⁸ may mutually independently mean C₁ to C₄ alkyl, C₅ to C₈ cycloalkyl or C₆ to C₁₄ aryl, and 1,4-dichloro-2-butene, 3,4-dichloro-1-butene or a mixture of the two at temperatures in the range from 40 to 180° C.

8. A process for isomerizing 1,4-dichloro-2-butene to yield 3,4-dichloro-1-butene or 3,4-dichloro-1-butene to yield 1,4-dichloro-2-butene, wherein the process comprises the step of adding
a) an iron compound selected from among the group consisting of iron carbonyls, Fe(CO)₅, Fe₂(CO)₉, Fe₃(CO)₁₂ or of anhydrous iron salts FeₘXₙ, wherein m=1 or 2 and n=2 or 3 and X=halide, carbonate, nitrate, nitrite, sulfide, sulfate, phosphate, rhodanide, acetate, acetylacetonate or a mixture of two or more of these compounds, with a cyclopentadiene derivative of the general formula I, 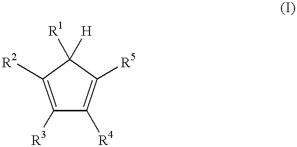
wherein
R¹ to R⁵ mutually independently denote H, C₁ to C₁₂ alkyl, C₅ to C₈ cycloalkyl, which may in turn bear C₁ to C₁₂ alkyl groups, C₆ to C₁₄ aryl, alkylaryl, arylalkyl, wherein two adjacent residues may together form saturated or unsaturated C₃ to C₁₄ cycles, or denote —SiR⁶R⁷R⁸, wherein R⁶ to R⁸ may mutually independently mean C₁ to C₄ alkyl, C₅ to C₈ cycloalkyl or C₆ to C₁₄ aryl,
to 1,4-dichloro-2-butene or 3,4-dichloro-1-butene at a temperature in the range from 40 to 180° C. to form a reaction solution,
wherein the order in which the catalyst components are added is generally irrelevant,
b) allowing the reaction solution to react until an equilibrium between 1,4-dichloro-2-butene and 3,4-dichloro-1-butene is established, between 1 and 180 minutes,
c) continuously removing a mixture of 1,4-dichloro-2-butene and 3,4-dichloro-1-butene and then separating by distillation,
d) introducing the unwanted component from the distillation performed in c) into the reaction system and optionally
e) simultaneously with c), supplying 1,4-dichloro-2-butene and/or 3,4-dichloro-1-butene to the reaction system.

9. A process according to claim 8, wherein the temperature in step a) is in the range from 100 to 150° C.

10. A process according to claim 8, wherein the reaction time in step b) is in the range of 15 and 45 minutes.

11. A process according to claim 8, wherein in step a) a prepared composition is used in concentrations in the range from 10⁻¹ to 1 mol of Fe/L in 1,4-dichloro-2-butene and/or 3,4-dichloro-1-butene and this composition is added to 1,4-dichloro-2-butene, 3,4-dichloro-1-butene or a mixture thereof.

12. A process according to claim 8, wherein the individual components are mixed together.
